(19) United States
(12) Patent Application Publication
(10) Pub. No.: US 2011/0021273 A1
(43) Pub. Date: Jan. 27, 2011

(54) INTERACTIVE MUSIC AND GAME DEVICE AND METHOD

(76) Inventors: Caroline Buckley, Glen Ridge, NY (US); Adam DeVito, San Francisco, CA (US); Quillon Tsang, Sausalito, CA (US); Matthew Peter deVito Brown, Berkeley, CA (US); Greg Easley, New York, NY (US)

Correspondence Address: DLA PIPER LLP (US ), 2000 UNIVERSITY AVENUE, EAST PALO ALTO, CA, 94303-2248, US

(21) Appl. No.: 12/567,489

(22) Filed: Sep. 25, 2009

Related U.S. Application Data
(60) Provisional application No. 61/100,690, filed on Sep. 26, 2008.

(51) Int. Cl. A63F 13/00; A63F 13/06

(52) U.S. Cl. 463/31; 463/35; 463/36; 463/39

(57) ABSTRACT

A body DJ device and method are provided.

### PRIORITY CLAIM/RELATED APPLICATIONS

This application claims the benefit under 35 USC 119(e) and claims priority under 35 USC 120 of U.S. Provisional Patent Application Ser. No. 61/100,690 filed on Sep. 26, 2008 and entitled “Interactive Music and Game Device and Method”, the entirety of which is incorporated by reference herein.

### FIELD

The device and method relate generally to a music generation video game and device.

### BACKGROUND

Devices exist that allow a person to play or interact with music. For example, Apple® iPods® and mp3 players that allow a user to play music or videos, but the user's experience is passive (meaning that the user cannot interact with the music being played) and has a defined result (meaning that the selected song or songs are played and the user cannot alter or change the music). There are also products such as EZDJ, MP3 DJ or MiJam that are still passive, but allow the user to have some control over the result/experience. Traditional musical instruments also allow the user to have creative control over the experience and are mildly active. In addition, there are products like Guitar Hero, Rock Band, the Wii console and Dance Dance Revolution that have the defined experience but are very active. Thus, none of the existing systems provide a musical experience that is both maximally active and creative, but it is desirable to provide such an experience wherein people can create, select and manipulate music and other audio like a disc jockey or other musical entertainer using a device or combination of devices that create the potential for full body, highly active movement.

### BRIEF DESCRIPTION OF THE DRAWINGS

FIG. 1 illustrates an embodiment of an interactive music/game device.

### DETAILED DESCRIPTION OF ONE OR MORE EMBODIMENTS

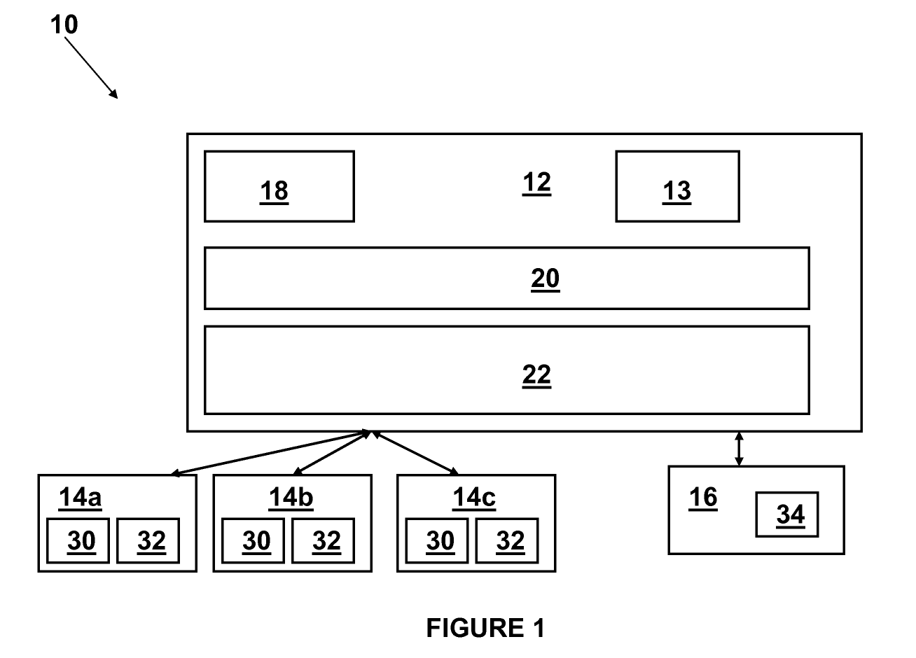

FIG. 1 illustrates an embodiment of an interactive music/game device 10. The interactive music game/device is a game/music system that inspires kids and adults to explore music, self-expression and performance through full body movement because, using the interactive device 10, a user can create music, manipulate songs and create sound effects by moving their bodies skillfully or dancing in different ways as described in more detail below.

The device 10 may include a game unit/device 12 that is a device that receives signals from external sensors as described below and generates songs/music/tones, that may or may not be altered by the user using the external sensors, through a set of output devices 13, such as speakers. The external sensors may include one or more wearable sensors 14, such as a set of sensors for the hands/wrists of the user and one or more sensors that attach to the leg/foot of the user, that allow the user to manipulate a song/music or tones using body movements and a sound input device 16, such as a microphone, that allows the user to add audio signals into the music/song or tones.

Alternatively to the device above that has the game unit/device 12 with the external sensors, the device 10 may be a game (that can be implemented as a plurality of lines of computer code that are executed by a processing unit of an existing processor based console such as the Microsoft® Xbox 360, Nintendo® Wii, Sony® Playstation 3 and the like) that can be used with motion-sensing peripherals that were announced after Sep. 26, 2008 for existing systems such as Sony® PlayStation 3 and Microsoft® Xbox 360 or motion sensing peripherals such as for the Nintendo® Wii. In these embodiments of the device 10, the game may include one or more pieces of music stored in a storage unit associated with the game, a plurality of lines of computer code that implement an interface for one or more output devices associated with the processor based console for generating sounds and a plurality of lines of computer code that implement an interface to one or more input devices capable of being coupled to the processor based console.

The controller for the Nintendo® Wii, known as the Wiimote, is a first-generation technology featuring an infrared light sensor combined with an accelerometer to provide relatively accurate “point-and-click” functionality and motion sensing in 3D space. The system's IR sensor can determine where the Wiimote is pointing on the screen regardless of television type and allows for accurate sensing up to 16 feet away. The Wiimote allows the player to mimic actual game actions, such as swinging a sword or aiming a gun, instead of simply pressing buttons. The Wii is available today, with a global installed base of over 50 m units. In June, Nintendo® released the MotionPlus add-on for the Wiimote to improve accuracy. Thus, the device 10 may be game that is played on the Nintendo® Wii with the Nintendo® controller as described above.

Microsoft's recently announced motion-sensing technology (code-named Project Natal) allows for a camera-based, controller-free game experience. Designed as an add-on peripheral for the Xbox 360, the Natal system allows users to control games and applications via movement and spoken commands rather than traditional game controllers. The device features an RGB camera, infrared depth sensor, multi-array microphone, and custom processor running proprietary software to provide full-body 3D motion capture, facial recognition, and voice recognition capabilities. The skeletal mapping technology shown at E3 2009 was capable of simultaneously tracking up to four users simultaneously. Depending on the player's distance from the camera, Natal is capable of tracking the motion of individual fingers, allowing for accurate puppet-like control of in-game characters and objects. Natal is set to launch with an updated version of the Xbox 360 hardware in late 2010. The Xbox 360 has a global installed base of 30 m units. Thus, the device 10 may be game that is played on the Microsoft® Xbox 360 with the depth sensing camera as described above.

The Sony® Playstation 3 has a PlayStation 3 Motion Controller that is a camera-based control system that Sony announced in June. It is similar to Nintendo's Wiimote but utilizes different technology for increased accuracy. Players will use one or two handheld controllers (known as wands) that have multiple buttons and an illuminated color-changing orb on the end of each wand. The orb serves as an active marker, the position of which can be tracked in 3D space by the PlayStation Eye, the PlayStation 3's camera peripheral. The system also includes an accelerometer and ultrasonic microphone to increase accuracy. The PlayStation 3 has an installed base of 23 m units worldwide; the Motion Controller is scheduled for release in spring 2010. Thus, the device 10 may be game that is played on the Sony® Playstation 3 with the camera based control system as described above.

In addition, the device may interface with a depth-sensing video camera integrated with miniature computer that can be plugged directly into a television (this is a self-contained game console housed within the camera casing).

In one embodiment in which the game unit/device is implemented using a processing unit and one or more pieces of software, the game unit/device 12 may further include one or more processing units 18, a memory 20 and a set of input/output interfaces 22. The game unit/device 12 may be a game unit sold with the wearable sensors, etc. (a self-contained game unit) but may also be a commercially available for personal computer or gaming consoles, like Xbox, Wii, PlayStation, etc., onto which a game cartridge, DVD, software, etc can be installed to provide the interactive music game functionality. The memory 20 may store a plurality of lines of computer code, such as in one or more software programs and/or modules, that, when executed by the processing units 18 control the operations of the output devices 13 and control the external sensors. The software may also include modules to create and manipulate sound effects, mix audio files, control a software equalizer and/or change words that are spoken/sung into musical notes or sound effects. The software may also include software that allows the user to select music, select one or more game modes (described below in more detail) and a number of players and set a difficulty level of the game mode. The memory 20 may additionally contain one or more pieces of music/songs or tones that a user using the device can manipulate using the external sensors as described below. The set of input/output interfaces may include interfaces/circuitry for the set of output devices, the external sensors as well as an interface for an external device, such as an iPod or other device, that may be used to download music/tones or songs into the device 10 so that the user can manipulate those music/tones or songs which they have already acquired or purchased. The unit 12 may also allow the user to store his/her manipulated song/tone or music in the memory and then share it wirelessly or by downloading it to a removable memory device that may be part of the unit 12. The unit 12 may also permit the user to connect to a link, such as the Internet, to a website, etc. from which the user can share their songs/music or tones. Using the device 10 and the set of external sensors, the user can manipulate songs/tones or music and sounds based on moving their bodies in different ways to trigger different effects. The game unit/device may also be connected to a typical television in which the television is used as the display for the game unit/device.

In an implementation of the interactive music/game unit 10, the set of output devices 13 may be speakers located on the outside of the unit 12, the one or more manipulatable sensors 14 may include a left hand/wrist sensor 14a, a right hand/wrist sensor 14b and a foot/leg sensor 14c that can be worn by the user (and each hand/wrist sensor and foot/leg sensor has one or more sensors 30 embedded therein that translate movement of the body of the user into different effects and/or manipulations of the song/music/tones and a wireless transceiver 32 that allows each hand/wrist sensor and foot/leg sensor to communicate wirelessly with the unit 12, such as by radio frequency (RF) energy) and the sound input device 16 may be a headset with a microphone that can be worn by the user and has a wireless transceiver 34 that allows the sound input device to communicate wirelessly with the unit 12, such as by RF energy. The sound input device allows a user to talk or sing into the microphone and to create cool digitized/computer sound effects that further brings the DJ experience to life. In one implementation, each hand/wrist sensor and each leg/foot sensor may have an accelerometer or other technology that enables tracking of motion direction, speed and orientation in space of the sensor and therefore the body of the user.

The device 10 may also have an associated website, such as www. BodyDJ.com, where a user can upload songs as well as cool sound effects for other users in the community to download and use. A user can also submit videos for others to view. The website may also have sponsored contests that allow users to vote online for their favorite video or audio tracks and win prizes.

In one implementation, a user using the unit 12 may associate particular movements of each hand/wrist sensor with an associated sound effect such as, for example:
Move hands back and forth horizontally=scratching sound
Finger tips together=particular sound effect chosen by user
Palms together=particular sound effect chosen by user
Hand completely crossed like praying=filtering (puts sound in a box)
Two fists together=particular sound effect chosen by user
Specific finger connections (ex.—Right finger to left thumb)=particular sound effect chosen by user
Hands up=volume up
Hands down=volume down

In the Matching and Freestyle Dance Modes described below, the game may support the following moves/body movements:
Hands shoot up from the hip=Saturday Night Fever
Both hands lifted up over the head=Raise the roof
One arm waved in an arc over the head=Long wave—vocal “Hey-Ho”
Each hand churns air in front of the chest=butter churn
Hands pass over the eyes like Uma Thurman in Pulp Fiction=Bat-Tusi
Left arm in air, waved side to side=Hangin' Tough
Undulate both arms in a vertical plane with the shoulders=Flying Loose
Raise wrist under chin and paw the air occasionally—Austin Powers
Hold arms straight down and rotate forearms from the elbow=Robot

In the Remix mode described below, the game may support the following moves/body movements:
Right arm out & back from chest x2 (or x4)=Simple Record Scratch
Simple Record Scratch+arm traces counter clock=Long Scratch
90 degree right forearm swing=gun shot
Lower 90 degree left forearm swing—breaking glass
Right arm extended out to side with elbow fully bent and forearm moves up and down rapidly=Tremolo
Left arm starts from bottom, Right arm starts overhead both arms move in opposite directions=changes underlying rhythm
Right and left hands hit drum mid air=drum fill
Right arm starts at side and traces a overhead “rainbow” arc. Going in one direction yields a “hey” from the audience while going in the other direction elicits a “ho”=crowd call
Right or left foot kicks low to ground=cut out frequencies above 400 Hz
Right and left hands together “slice” in diagonal motion from up to down=trailing sound
Right and left hands start extended in opposite corners and slowly come together at players navel then move back away=Phasey envelope flange effect
Right and left start together & left foot slides away and then right foot follows=music plays in reverse

Using the device 10, the user using the device can control the music through the movement of the body of the user. For example, the user can select any sound effect to be associated with the hand/wrist sensors (such as, for example, percussion, guitar, even song smashing), place the song input device on his/her head and select a play mode from the unit 12, such as compose, add sound effects to a preprogrammed song or a song from your iPod or mix two songs together. Then, the user can start moving to manipulate the song/music or tones. For example, the user can shake his/her hands horizontally to “scratch” the record, drop his/her hands to decrease volume, Clasp his/her hands together and filter the music, touch fingertips together and hear more bass, or dance into an artful performance.

In one implementation, the game/device may include a practice mode, a freestyle mode and a game mode.

Practice Mode

In this mode, a user can learn specific sequences that create various sound effects for use later in the Freestyle or Game mode. In the modes, the sensors described above can be used. Alternatively, using the Project Natal system described above, a user can assign content/values to different appendages that can be used during the play.

Freestyle Mode with 3 Ways to Play:

1. Default Setting: Select a song from the base unit and wrist sensors are automatically loaded with audio add-ins that complement the background song. The user can move his/her body and experiment with the audio additives. The default freestyle mode may also include avatars that are moving to the beat set by the user in a virtual hip hop performance.

2. Choose Audio Add-Ins: The user can choose audio add-ins (add new audio on top of existing tracks) by loading up the wrist sensors with multiple varieties. The user can select the button (discreet location) corresponding to the desired audio add-in and move his/her body to manipulate the new, additive audio. The user can also press the button again to deactivate the additive audio selection. The audio add-ins include:

A) Record Scratch (control speed, repetition)

B) Percussion (control speed, repetition, type)
Types of “percussion audio add-ins” include bass, snare, toms, cymbals, xylophones, marimbas, Glockenspiels, etc. as well as different types of drums such as Reggae, Latin, Rock, etc.

C) Vocals (control speed, repetition, type)
Recorded by user or pre-programmed D) Non-percussion sounds (control speed, repetition, type)
Guitar riffs, horns, whistles, etc.

3. Choose The Sound Effects (manipulating existing tracks). Pre-programmed DJ Sound Effects are activated by pressing discrete button(s) on the wrist/hand sensors to toggle on/off DJ sound effects that are triggered by completing the designated body movements. Sound effects include:
Echo/Delay—3 Hand Bounces (like dribbling a basketball)
   Echos the measure of music that was playing when the third bounce is completed
      Best heard at the end of a distinct sound
      Effect can be done on beat
Flanger*—Hands together, apart and then back together
   Filtered arch, roundness, arc can be adjusted
   Doubles and slightly off-times them and then moves that space around
Pitch control*
   Adjusts tempo at the same time
Filter (low pass or high pass)*
   Takes sound to the low or high end (take out bass or treble)
Transformer*
   Cuts out little pieces of the file
   The user can change frequency with which the user is taking out pieces
   Sounds cool when the user gets the frequency in line with beats per minute of the music
Song Smashing*—stomp to the beat to pick up the rhythm of song 1, then do specific body movement to pull in song 2 and when ready do another specific body movement to drop song 1 entirely
Reverse—Sling Back Move (rotate right arm over left, left arm over right and then drop right hand down in a whip motion)
   Music plays backwards for two seconds each time the sequence is completed (to play backwards for four seconds, do the sequence twice)
Panning—Hands up in the air to the right and then to the left or vice versa
   When hands are to the right of the midline of the body, the sound moves to the right speaker. When hands are to the left of the midline of the body, the sound moves to the left speaker.

*indicated sound effects that are believed to be the most compelling for users.

Game Modes—Compete or Collaborate in Various Challenges Including:

Compete—World DJ Challenge

Player starts out in a basement setting and has to complete a certain number of levels (as embodied via prestige of performance venue for any given battle) to prove his ability and work his way out of the basement and into the club scene and ultimately into various local, regional and world battles. All players take on unique personalities based on their selected avatars that carry unique back stories that help create an immersive fantasy experience.

A box on one side of the screen shows 4 icons that represent 4 different movements (each tied to a particular audio add-in or sound effect) you can select from to integrate into the music during a given time period. These 4 icons are constantly changing throughout the song. When you successfully complete one of the 4 movements and it is “on beat” (as measured by quantizing the rhythm and comparing it to the beats per second on the background music track), you get the corresponding points associated with that movement. The 4 movements vary in complexity and therefore point value (bling). The higher the complexity, the greater the crowd participation and enthusiasm (whistling, raising the roof, etc.). For example, song smashing is a more difficult skill and a successful execution delivers more “bling” than adding a record scratch. The player can learn which icons deliver higher point values (bling) by watching the crowd to inform his music and audio add-in selections. The box continuously refreshes to offer 4 new icons after a movement is completed and points are awarded. As a player completes a level (made up of a series of successfully completed movements), he gets rewarded with a) bling (tied to the fans' reaction to the performance) that can be used to buy stuff for their virtual world and avatar (gold necklaces, diamonds, cars, DJ equipment, etc.) and b) access to new audio add-ins and sound effects that are saved and used in current game play as well as future Freestyle play. Game continues until a) player accumulates a certain # of “faults”, as determined by inaccurate body movement (wrong moves) or inaccurate timing (not on beat) or b) player advances through all possible levels and earns a certain amount of bling. Social play is enabled through two-player DJ battles where players go head-to-head in a tournament-style match-up. Bling can also buy branded virtual DJ equipment that is tied to sponsorship/product placement revenues.

Collaborate—DJ Jam Session

Up to 4 players can collaborate to produce music compilations using any combination of the following roles:

DJ 1—audio add-ins and sound effects

DJ 2—audio add-ins and sound effects

Dancer 1—dance on beat

Dancer 2—dance on beat

MC/Rapper 1—hype up the crowd and rap on beat

MC/Rapper 2—hype up the crowd and rap on beat

Icons appear in a scrolling fashion and move from the top of the screen to the bottom. The player must do the move or vocal (for MC/Rapper) associated with the icon on beat, as indicated with overlapping visual cues (do the move when the icon is centered around the move zone). The team receives points (bling) based on the crowd's reaction (increases the more on beat and on target the moves and vocals are). Players accumulate faults when they fail to react on beat. When a player reaches a certain # of faults, he is forced to drop out unless another player completes a rap challenge to generate enough crowd excitement to get the player back on stage.

At the beginning of a song—in Matching Mode—executing correct sequences of body movements will result in a point multiplier that engages Freestyle Dance Mode, which allows players to improvise and mix up the dance moves they have learned. As players execute moves, they will fill up the remix meter and be able to enter Remix Mode with a clap of their hands. Remix Mode offers an opportunity for improvised percussion, record scratches, and pre-recorded samples to be triggered during a portion of the performance. Special moves in Remix Mode will allow the player to alter the music mix by filtering the sound, adding delays, or combining songs, resulting in a limitless variety of musical options for the player to manipulate.

Specific movements and gestures made by the player's body will act like controller inputs, similar to pressing buttons on a gamepad. The challenge for the player is to execute the moves at the right time from a physical standpoint: in dance, as in music, precision is critical. If players get in over their heads, songs will careen out of control, and euphony will become cacophony. But when successful, players will experience the feeling of having created real music and dance, without having to master individual instruments or extremely challenging physical moves.

In another embodiment, the game may include an animated character, centered in the screen, that will play the role of a dance instructor. The instructor will face the player, and the player's goal will be to match the moves as if he is looking in the mirror.

While the foregoing has been with reference to a particular embodiment of the invention, it will be appreciated by those skilled in the art that changes in this embodiment may be made without departing from the principles and spirit of the invention, the scope of which is defined by the appended claims.

1. An interactive musical game, comprising:
one or more wearable sensors capable of being coupled to a unit that is capable of containing one or more pieces of music, a manipulating unit and one or more output devices for generating sounds;
a sound input unit capable of being coupled to the unit; and
wherein a user moves the one or more wearable sensors which cause the manipulating unit to manipulate a selected piece of music based on one or more particular movements of the one or more wearable sensors.

2. The device of claim 1, wherein the one or more wearable sensors further comprises a hand sensor.

3. The device of claim 1, wherein the one or more wearable sensors further comprises a foot/leg sensor.

4. The device of claim 1 further comprising a recorder that records a game with the manipulated piece of music.

5. The device of claim 4, further comprising an interface for sharing the recorded game.

6. The device of claim 1 further comprising a television connectable to the unit that acts as a display for the unit.

7. The device of claim 6, wherein an avatar is displayed on the television when a user moves the one or more wearable sensors which cause the manipulating unit to manipulate a selected piece of music based on one or more particular movements of the one or more wearable sensors.

8. The device of claim 1 further comprising a set of speakers for outputting sound.

9. An interactive musical game, comprising
a game executed on a processor based device;
the game having one or more pieces of music, an interface to one or more output devices associated with the processor based device for generating sounds and an interface to one or more input devices capable of being coupled to the processor based device; and
wherein the game manipulates a piece of music based on the movement of the one or more input devices by a user.

10. The interactive game of claim 9, wherein the game generates an avatar on a display of the processor based console and wherein the avatar moves on the display based on the movement of the one or more input devices by a user.

11. The interactive game of claim 10, wherein the game further comprises a dance instruction character and the player matches a series of moves of the dance instructor.

12. The interactive game of claim 9, wherein the processor based device further comprises a processor based gaming console and wherein the one or more input devices further comprise a motion sensitive controller.

13. The interactive game of claim 12, wherein the processor based gaming console further comprises a Microsoft® Xbox 360 device and the motion sensitive controller further comprises a depth sensing three-dimensional camera.

14. The interactive game of claim 12, wherein the processor based gaming console further comprises a Nintendo® Wii device and the motion sensitive controller further comprises a Wiimote device.

15. The interactive game of claim 12, wherein the processor based gaming console further comprises a Sony® Playstation 3 device and the motion sensitive controller further comprises a camera base control system.

16. The interactive game of claim 9, wherein the game further comprises one of a game cartridge and a piece of software having a plurality of lines of computer code.

17. The interactive game of claim 9, wherein the processor based device further comprises a depth-sensing video camera integrated with miniature computer.
